(19) United States
(12) Patent Application Publication
(10) Pub. No.: US 2014/0293810 A1
(43) Pub. Date: Oct. 2, 2014

(54) METHOD FOR IDENTIFYING OPTIMAL INFLUENCIAL PATHS IN A DISTRIBUTED NETWORK FOR TRANSMITTING INFORMATION

(71) Applicant: WHISTLE TALK TECHNOLOGIES PVT. LTD., Bangalore (IN)

(72) Inventors: Ajay Kumar NEMA, Bangalore (IN); Manish Kumar NEMA, Sagar (IN); Mohan Kumar PANDIAN, Tuticorin (IN); Roopesh Kumar NEMA, Sagar (IN); Saravanan SOUPRAMANIANE, Villianur (IN); Siva Kiran DHULIPALA, Bangalore (IN); Vinoo M. CHACKO, Thiruvananthapuram (IN)

(21) Appl. No.: 14/229,424

(22) Filed: Mar. 28, 2014

(30) Foreign Application Priority Data
Mar. 28, 2013 (IN) 4082/CHE/2012

(51) Int. Cl. H04L 12/721

(52) U.S. Cl. CPC H04L 45/14
USPC 370/252

(57) ABSTRACT

The present disclosure is related to a method for identifying optimal influential paths in a distributed network for transmitting information/request to one or more target nodes. The routing server at the source node identifies one or more target nodes in the network based on information. Thereafter, routing server identifies one or more optimal nodes based on influence value associated with each node in network and determines predicted action that will be performed by the optimal node and transmits the information to each optimal node. Each optimal node performs an action upon receiving the information from the source node. The routing server receives the data related to the operation performed and updates influence value associated with respective nodes. The routing server identifies one or more optimal paths based on one of the influence value being updated and the action performed by each optimal node.

### TECHNICAL FIELD

The present disclosure relates to distributed network technologies. In particular, the present disclosure relates to a method for identifying optimal influential paths in a distributed network for transmitting information to one or more target nodes.

### BACKGROUND

A distributed network is a network structure in which each node is connected to one or more nodes through one or more links. The one or more links between the nodes is at least one of wired or wireless. The one or more Nodes may include, but not limited to, hosts such as personal computers, phones, servers and any other networking hardware device.

Presently, one of problems in the distributed network is relying on expertise of an individual node to receive responses for some specific information needs or requirements. In this context, one can assume that any two nodes in the distributed network are connected by one or more paths. Moreover, expertise [which has response to the information] tends to be distributed throughout the distributed network such that, for any information need, there are one or more nodes within the network for which, partial or full answer to the query is easily at-hand. Thus, in general, there exists, for most queries, one or more nodes at varying distances from the query originator node, which may respond based on the available full or partial information to the query. When an information request reaches a node, there is a choice available to the node, whether or not to take any action on the information request. The problem, however, is that while a path to a query's answer node(s) or information node may exist within the distributed network, the optimal influential path, which will influence a node to take a set of desired action when triggered by an information request is typically hard to identify.

One of the conventional methods discloses a means of implementing a computer-based personal contact manager that allows members to create and maintain contacts with other members and in doing so incorporate their contact details on their personalized address books. As further members join the group, their contact details are optionally incorporated in the address books of the existing members. Furthermore, any changes in the contact details of the members are automatically updated in the address books of the other members. However, the system is primarily directed to maintaining connectivity between individuals by updating their contacts details, rather than sharing information between members of a network and identifying one or more optimal paths for transmitting information to one or more target nodes in the distributed network.

Another conventional method discloses a multi-level award program in which the internet activity of an enrolled user is tracked with award points being earned for various specified activities. Further bonus points can be accrued by the user from other “second, third, fourth level” users and so on. But this method does not teach any means of selective interaction within a group of entities known directly or indirectly to each other based on which one or more optimal paths are identified for transmitting information to one or more target nodes.

Hence, there exists a need for a method to identify optimal influential paths in the distributed network for transmitting the information to one or more target nodes.

### SUMMARY

The shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

The present disclosure provides a method for identifying one or more optimal influential paths in a distributed network for transmitting information to one or more target nodes. The routing server at a source node identifies one or more optimal nodes from a plurality of nodes configured in the distributed network based on an influence value associated with each node in the distributed network and transmitting the information to each of the one or more optimal nodes. The routing server also determines a predicted action to be performed by each optimal node. Upon receiving the information, each optimal node performs an action. The method further comprises receiving data from each of the one or more optimal nodes, wherein the data is associated with the action performed by each of the corresponding one or more optimal nodes. Thereafter, the routing server updates, in an influence database configured in the routing server, the influence value associated with each of the one or more optimal node based on difference between the action performed and the predicted action being determined. The routing server identifies one or more optimal paths in the distributed network for transmitting the information to the one or more target nodes based on one of the influence value being updated and the action being performed by each of the one or more optimal nodes, wherein the action being performed is one of forwarding the information to another node, sharing the information to at least one node and responding to the information received from the routing server.

The present disclosure provides a routing server for identifying one or more optimal paths in a distributed network for transmitting information to one or more target nodes. The routing server comprises at least one processor and a memory storing instructions executable by the at least one processor, wherein the instructions configure the at least one processor to identify one or more optimal nodes from a plurality of nodes configured in the distributed network based on an influence value associated with each node in the distributed network, determine predicted action to be performed by each of the one or more optimal nodes and transmit the information to each of the one or more optimal nodes, receive data from each of the one or more optimal nodes, wherein the data is associated with the action being performed by each of the corresponding one or more optimal nodes, update, in an influence database configured in the routing server, the influence value associated with each of the one or more optimal node based on the difference between the action performed and the predicted action being determined and identify one or more optimal paths in the distributed network for transmitting the information to one or more target nodes based on one of the influence value being updated and the action being performed by each of the one or more optimal nodes, wherein the action being performed is one of forwarding the information to another node, sharing the information to at least one node and responding to the information received from the routing server.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristics of the disclosure are set forth in the appended claims. The embodiments of the disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an exemplary environment for identifying one or more optimal paths in a distributed network in accordance with some embodiments of the present disclosure;

FIG. 2 illustrates a block diagram of a routing server in accordance with some embodiments of the present disclosure;

FIG. 3 illustrates an exemplary process for determining relationship between the nodes in the distributed network in accordance with some embodiments of the present disclosure;

FIG. 4 illustrates an exemplary process of influencing a node by more than one node based on the operations performed, in the distribution network in accordance with some embodiments of the present disclosure;

FIG. 5 illustrates an exemplary process of identifying one or more optimal paths in the distributed network in accordance with some embodiments of the present disclosure; and

FIG. 6 shows a flowchart illustrating method for identifying one or more optimal paths in the distributed network for transmitting information to one or more target nodes in accordance with some embodiments of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

As used herein, the terms “optimal path” refers to an ideal path/route for transmitting information from a source node to a destination node in the distributed network, “target nodes” refers to one or more destination nodes in the distributed network for which the information has to be reached and a predetermined action/operation being performed.

In an embodiment, the present disclosure provides a method of identifying one or more optimal influential paths between a source node and a destination node in the distributed network for transmitting information to the destination node. The source node identifies one or more optimal nodes in the network for transmitting the information. The one or more optimal nodes are identified based on an influence value associated with each node in the distributed network. The influence value quantifies the relationship between the source node and each of the one or more optimal nodes. The source node comprises an influence database for storing the influence value associated with each of the one or more nodes in the distributed network. Each of the one or more optimal nodes performs an operation based on the information received from the source node. The source node receives data associated with the operation performed by each optimal node. Based on the received data, the source node updates the influence value for each node in the network. The updated influence value is stored in the influence database. The source node identifies one or more optimal paths in the distributed network for transmitting the information to the one or more target nodes based on one of the influence value being updated and the operation performed by each of the one or more optimal nodes, wherein the operation performed is one of forwarding the information to another node, sharing the information to at least one node and responding to the information received from the routing server.

In an example embodiment, the present disclosure can be implemented for finding out the best route to reach a candidate eligible for a given job profile. Considering that a hiring manager of a company posts a job posting and shares it with a recruiter of the company. The recruiter forwards the job posting to one or more potential candidates. The influence exerted by the recruiter on each of the potential candidate depends on the influence power of the recruiter and their relationship. In many cases, the potential candidate ignores the message from the recruiter. An alternate path to route messages from the hiring manager to the potential candidate is to find a set of influential paths starting from the hiring manager to reach the potential candidate or reach the potential candidate through one of the candidate's friend who has more influence on the candidate, his friend, than an unknown recruiter.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

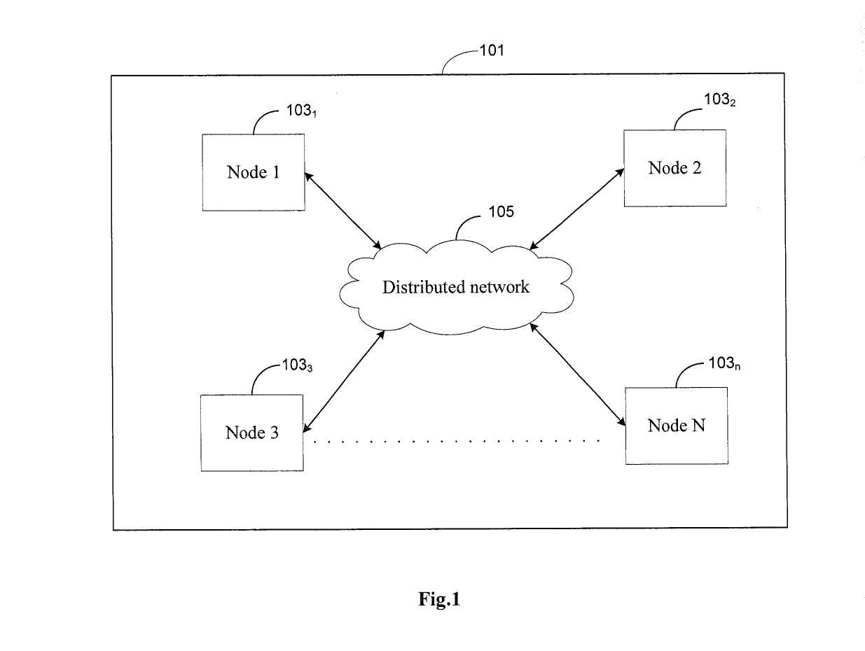

FIG. 1 illustrates an exemplary environment 101 for identifying one or more optimal paths in a distributed network 105 in accordance with some embodiments of the present disclosure. The environment 101 includes plurality of nodes, node 1 103₁ to node n 103ₙ (collectively referred as plurality of nodes 103) connected through a distributed network 105. The distributed network 105 may include, but not limited to, internet, relationships in a social network, entries in an address book, and wireless sensor networks. The plurality of nodes 103 may include but not limited to, hosts such as personal computers, phones, servers, any other networking hardware device, individuals in a social network and entries in an address book. The host node 103 in the distributed network 105 may be associated with a routing server (not explicitly shown in FIG. 1). The routing server is associated with a processing unit and a memory (not explicitly shown in FIG. 1).

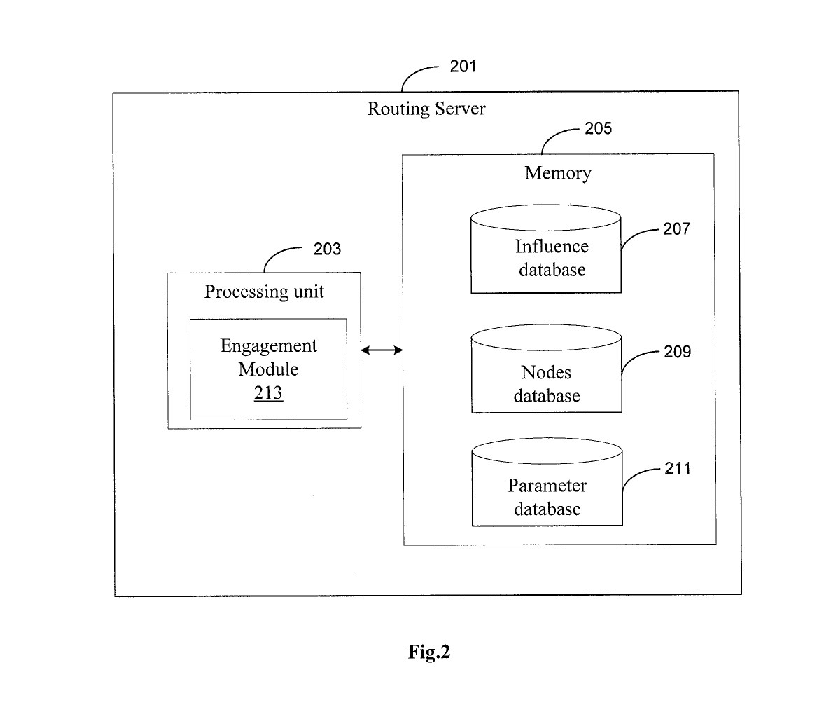

FIG. 2 illustrates a block diagram of a routing server 201 in accordance with some embodiments of the present disclosure. The routing server 201 comprises a processing unit 203 and a memory unit 205. The memory unit 205 includes an influence database 207, nodes database 209 and a parameter database 211. The processing unit 203 includes an engagement module 213. The engagement module defines a set of actions that may be performed by each node 103 in the distributed network 105 (also referred as network). In one embodiment, the set of operations includes, but not limited to, forwarding the information to another node, sharing the information with at least one node and responding to the information received from the routing server. During initialization or when a new connection between nodes is created, every pair of connected nodes is assigned a default value in the influence database 207.

The routing server 201 extracts one or more parameters associated with a request being received and stores the one or more parameters in the parameter database 211. The routing server 201 identifies one or more target nodes/destination nodes in the network 105. The one or more target nodes are the nodes to which the request has to be sent. The routing server 201 identifies one or more optimal nodes in the network. The one or more optimal nodes are those nodes 103 in the network 105 which has optimal influence on the target nodes. The one or more optimal nodes are identified based on the influence value associated with each node 103 in the network 105. The information related to each node in the network 105 such as the information of optimal nodes, information of target nodes is stored in the nodes database 209.

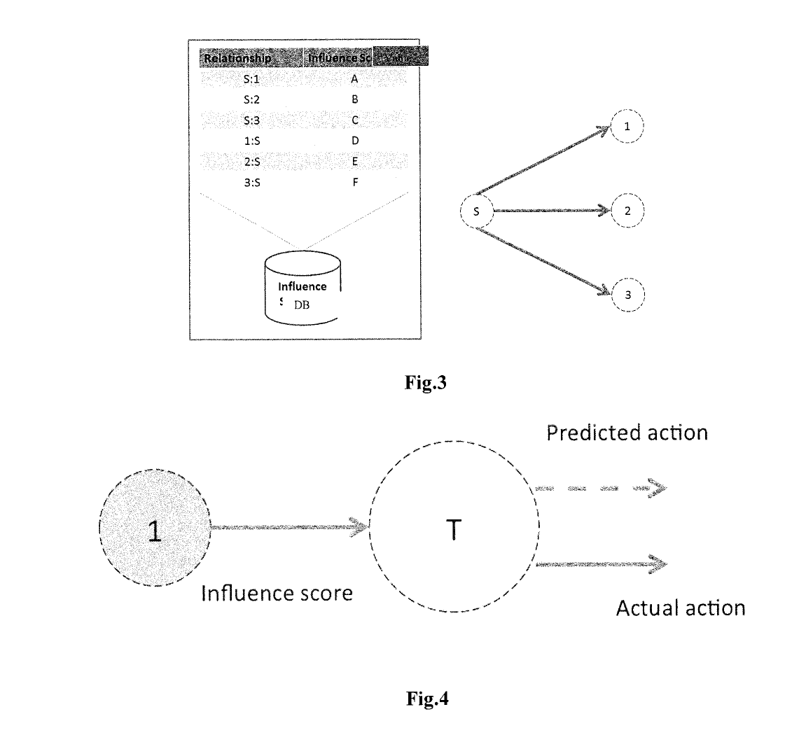

FIG. 3 illustrates an exemplary process for determining influence relationship between the nodes in the network. The influence relationship between the nodes 103 of the distribution network 105 may be either symmetric or asymmetric. As an example, Node S, Node 1, Node 2 and Node 3 are the four nodes in the distribution network. The Node S influences the Node 1 by imposing Node 1 to perform certain operations based on which the Node 1 performs one or more operations requested by the Node S. Based on the operations performed, the influence value between the Node S and the Node 1 is A. Similarly, the Node S influences the Node 2 for which the assigned influence score is B and the Node S influences the Node 3 for which the assigned influence value is C. Similarly, the Node 1 influences the Node S based on which the Node S performs one or more operations. Based on the operations performed, the influence value between the Node 1 and the Node S is D. Similarly, the Node 2 influences the Node S for which the assigned influence value is E and the Node 3 influences the Node S for which influence value is assigned as F. The influence value determines the level of influence a node has over the other nodes in the network. The routing server stores the influence value associated with each node in the influence database, for which the influence value A has the highest priority and F has the least priority. In some embodiments, the influence value may also be defined in terms of numbers.

In an embodiment, upon identifying the one or more optimal nodes, the routing server 201 transmits the request to each of the one or more optimal nodes. Upon receiving the request, each of the one or more optimal nodes extracts one or more parameters associated with the request. Based on the request received, each optimal node performs an operation, termed as an actual action/action performed. The action performed is a subset of all the engagement actions defined in the engagement module 213 and may include, but not limited to, one of forwarding the information to another node in the network, sharing the information to at least one node in the network, responding to the information received from the host node and rejecting the information received from the routing server.

FIG. 4 illustrates an exemplary process of influencing a node by another node in the distribution network. As an example, Node-1 and Node T are the two nodes in the distribution network. Node-T is an optimal node for the Node 1. The Node-1 exerts an influence on the Node-T, so that the Node-T performs a predicted action. For a given request, the Node-1, the Node-T, and the influencer value 1: T, the routing server computes the predicted action from among the set of possible actions in the engagement module 213. When the Node-T receives the request, it performs an action. The difference between the predicted action and the action performed creates a delta value, which is used to update the influence score 1:T, which is updated in the influence data base for future use.

The routing server 201 receives data related to the action performed by each optimal node. Based on the operation performed by each optimal node, the routing server 201 updates the influence value associated with each optimal node. If the operation performed by the optimal node is same as the predicted action, the routing server increases the influence value by a delta value and stores the increased influence value in the influence database. If the action performed by each optimal node is different from predicted action, then the routing server 201 decreases the influence value by a delta value and stores the decreased influence in the influence database.

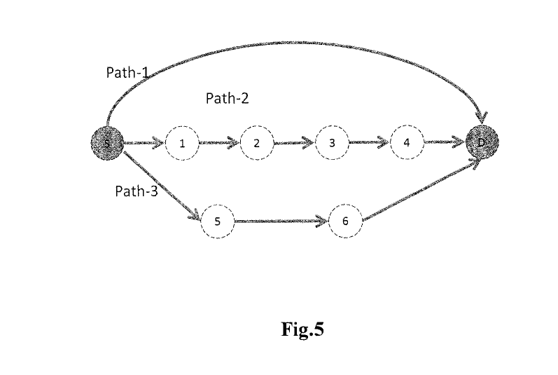

FIG. 5 illustrates an exemplary process of identifying one or more optimal paths in the network 105 in accordance with some embodiments of the present disclosure. Node S is a source node and node D is a target node. Node 1, Node 2, Node 3, Node 4, Node 5 and Node 6 are the other nodes 103 in the network 105. The Node S 103 is associated with a routing server 201. As an example, the routing server 201 at the Node S 103 provides information which is related to job requirement. The routing server 201 extracts one or more parameters associated with the information. The one or more parameters extracted are, but not limited to skill set defined for the given job requirement, description about the ideal candidates, profile of the company, job description and the experience required for the given job opening. These parameters are stored in the parameter database 211. The routing server 201 identifies that the Node D is the destination node for which the information has to be reached. The routing server 201 identifies that for transmitting the information to Node D there are three different paths, path 1, path 2 and path 3. Path 1 directly connects Node S to Node D. Path 2 is from Node S-Node 1-Node 2-Node 3-Node 4-Node D. Path 3 is from Node S-Node 5-Node 6-Node D.

To identify the optimal path out of three paths, path 1, path 2 and path 3, firstly the routing server 201 identifies one or more optimal nodes in the network 105 based on the influence value associated with each node in the network 105. In an example embodiment, consider the influence value associated with Node 1, Node D and Node 5 to be 100. The influence value associated with Node 2 is 75, Node 3 is 50, Node 4 is 25 and Node 6 is 15. The influence values associated with each node is stored in the influence database 207. Since the Node 1, the Node D and the Node 5 has the highest influence value, the Node 1, the Node D and the Node 5 are identified as the optimal nodes in the network 105. The Node S transmits the information to the Node 1, the Node D and the Node 5. Upon receiving the information, the Node 1, the Node D and the Node 5 extracts the parameters associated with the information and based on the parameters performs the action. In an embodiment, the engagement module 213 configured in the processing unit 203 defines the set of all operations that can be performed by each node in the network 105. In path 1, when the Node S forwards the information to the Node D the predicted operation for the Node D is responding to the information. But the action performed by the Node D is rejecting the information.

Similarly, the predicted operation defined for the Node 1 is to forward the information to the Node 2 in the network 105. The operation performed by the Node 1 is forwarding the information the information to Node 2. Similarly, the predicted operation defined for the Node 5 is to forward the information to the Node 6 and the operation performed by the Node 5 is forwarding the information to the Node 6. The data related to the operation performed by each Node in the network is transmitted to the routing server 201. The processing unit 203 updates the influence value based on the operation performed by the Node 1, the Node D and the Node 5. Since the Node D has rejected the information, the influence value is decreased by a value say 10 i.e the updated influence value S: D is 90. Since the destination Node-D has been reached and the desired action was not done by the Node-D, a path delta score, say 5 is deducted from all the nodes in the path. The updated scores are S: D=85.

Since, the operation performed by the Node 1 and Node 5 is same as the predicted operation, the processing unit 203 increases the value by 10 that is the updated influence value associated S:1 and S:5 is 110. In a sequence of events, the Node-2 forwards the information to the Node-3, which further forwards it to the Node-4, which further forwards the information to the Node-D. In this sequence of events, the influence scores of 1:2, 2:3, 3:4 have all be increased to 110. When the Node-4 forwards the information to the Node-D, it rejects the information. Therefore, the influence score associated with 4:D is decreased by 10, thereby becoming 90. Though the information which originated from Node-S reached the destination Node-D, without resulting in the predicted action, a path delta score, say 5 is deducted from all the nodes in the path. The updated scores are S:1=105, 1:2=105, 2:3=105, 3:4=105, 4:D=85.

In one embodiment for the Path-3, the Node 5 forwards the information to Node 6, which forwards the information to the Node D and the Node-D responds to the information. The routing server updates the influencer scores of S:5=110, 5:6=110 and 6:D=110. Since, the Path-3 resulted in desired action by the Node-D; each node in the path-3 is incremented by a path delta score of say 25. Therefore, the updated influencer scores are respectively S:5=135, 5:6=135 and 6:D=135. Therefore, Path 3 is emerged as the optimal influential path to reach Node-D and to get the predicted action out of Node-D. In subsequent routing of the request, Node-S will prefer using path-3 to reach Node-D and to influence a desired action out of Node-D.

The path delta score in the above example embodiment is to be either added or subtracted with the influencer scores associated with all the nodes in a path can be, but not limited to a configured value, computed value based on the number of nodes in the path.

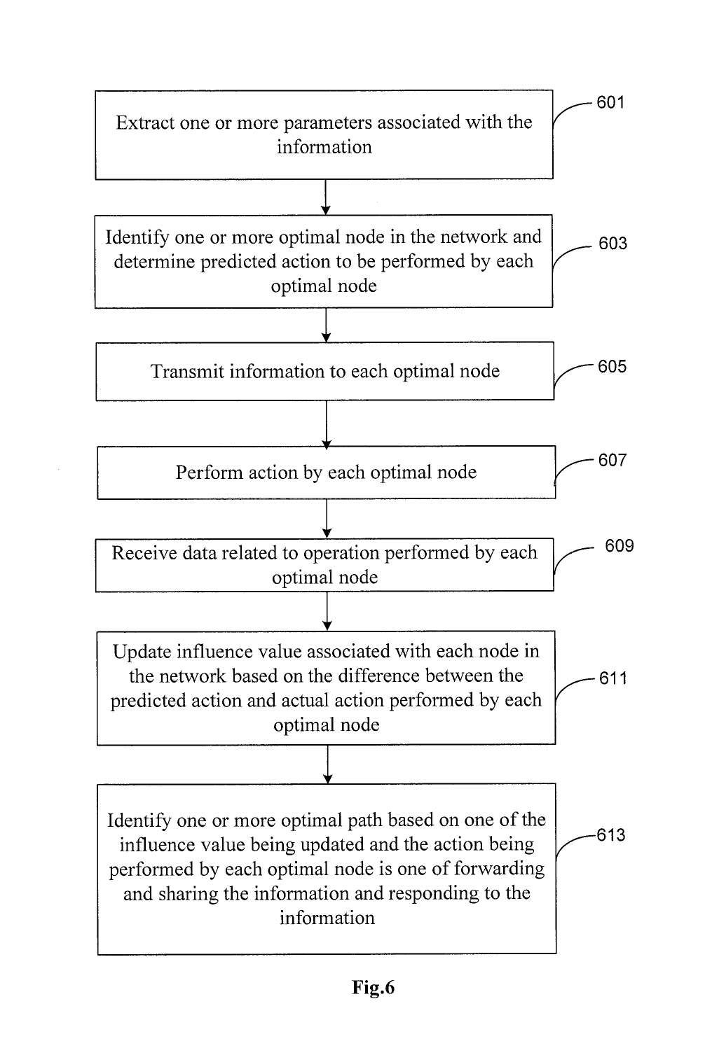

FIG. 6 shows a flowchart illustrating method for identifying one or more optimal paths in the distributed network 105 for transmitting the information to one or more target nodes in accordance with some embodiments of the present disclosure. The source node in the network 105 provides/creates the information. As shown in FIG. 6, at step 601, the routing server 201 at the source node extracts one or more parameters associated with the information to identify one or more target nodes. At step 603, the routing server 201 identifies one or more optimal nodes in the network based on influence value associated with each node in the network 105 and also determines the predicted action to be performed by each optimal node. Upon identifying the one or more optimal nodes, the routing server 201 transmits the information to each optimal node at step 605. At step 607, each optimal node performs an action upon receiving the information from the source node. The actions may include, but not limited to forwarding the information to another node in the network, sharing the information with at least one node in the network, responding to the information and rejecting the information received from the source node. At step 609, the routing server 201 receives the data related to the action being performed by each optimal node. At step 611, the routing server 201 updates the influence value based on the difference between the predicted action and the actual action performed by each optimal node by each node in the network. If the action being performed is one of forwarding the information to another node in the network, sharing the information with at least one node in the network, responding to the information, the routing server 201 increases the influence value by a value. If the operation performed is rejecting the information received from the source node, the routing server 201 decreases the influence value by a value. At step 613, the routing server 201 identifies one or more optimal paths in the distributed network for 105 transmitting the information to the one or more target nodes based on one of the influence value being updated and the action being performed by each of the one or more optimal nodes, wherein the action performed is one of forwarding the information to another node, sharing the information to at least one node and responding to the information received from the routing server.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor or a processor capable of processing and executing the queries. The CPU may include one or more processing units having one or more processor cores or having any number of processors having any number of processor cores. CPU may include any type of processing unit, such as, for example, a multi-processing unit, a reduced instruction set computer (RISC), a processor having a pipeline, a complex instruction set computer (CISC), digital signal processor (DSP), and so forth. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. Moreover, the terms “first,” “second,” “third,” and so forth, are used merely as labels, and are not intended to impose numerical requirements on their objects.

The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processor or by distributed processing units.

Additionally, advantages of present disclosure are illustrated herein.

In an embodiment, the present disclosure provides a method for identifying one or more optimal paths in the distributed network for transmitting the information to one or more target nodes.

In an embodiment of the present disclosure, the method reduces the computation complexity and time for transmitting the information using optimal influence so that the information is reached to the intended target node.

Finally, the language used in the specification has been principally selected for readability and instructional purposes, and it may not have been selected to delineate or circumscribe the inventive subject matter.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference | |
|---|---|
| Number | Description |
| 101 | Environment |
| 103 | Plurality of Nodes |
| 105 | Distributed Network |
| 201 | Routing server |
| 203 | Processing Unit |
| 205 | Memory |
| 207 | Influence Database |
| 209 | Nodes Database |
| 211 | Parameter Database |
| 213 | Engagement Module |

We claim:

1. A method for identifying one or more optimal influential paths in a distributed network for transmitting information to one or more target nodes, the method comprising:
identifying, at a routing server, one or more optimal nodes from a plurality of nodes configured in the distributed network based on an influence value associated with each node in the distributed network and transmitting the information to each of the one or more optimal nodes;
determining a predicted action to be performed by each of the identified optimal nodes;
receiving data from each of the one or more optimal nodes, wherein the data is associated with an action performed by each of the corresponding one or more optimal nodes;
updating, in an influence database configured in the routing server, the influence value associated with each of the one or more optimal node based on difference between the action performed and the predicted action being determined; and
identifying one or more optimal paths in the distributed network for transmitting the information to the one or more target nodes based on one of the influence value being updated and the action being performed by each of the one or more optimal nodes, wherein the action performed is one of forwarding the information to another node, sharing the information to at least one node and responding to the information received from the routing server.

2. The method as claimed in claim 1, wherein the action performed by each of the one or more optimal nodes is one of forwarding the information to another node, sharing the information with at least one node, responding to the information and rejecting the information received from the routing server.

3. The method as claimed in claim 1, wherein the influence value associated with each of the one or more optimal nodes is increased by a value if the action performed by each of the one or more optimal nodes is same as the predicted action determined by the routing server.

4. The method as claimed in claim 1, wherein the influence value associated with each of the one or more optimal nodes is decreased by a value if the operation performed by each of the one or more optimal nodes is different from the predicted action determined by the routing server.

5. The method as claimed in claim 1 further comprising assigning a path delta value for each path determined from a source node to a destination node in the distributed network.

6. The method as claimed in claim 5, wherein the path delta value is added to the influence value of all nodes in the path, if the destination node performs the action predicted by the source node.

7. The method as claimed in claim 5, wherein the path delta value is subtracted from the influence value of all nodes in the path, if the action performed by the destination node is different from the predicted action.

8. The method as claimed in claim 1, wherein each of the one or more optimal nodes obtains one or more parameters from the received information for performing the operation.

9. A routing server, comprising:
at least one processor; and
a memory storing instructions executable by the at least one processor, wherein the instructions configure the at least one processor to:
identify one or more optimal nodes from a plurality of nodes configured in the distributed network based on an influence value associated with each node in the distributed network and transmitting the information to each of the one or more optimal nodes;
determine a predicted action to be performed by each of the identified optimal nodes;
receive data from each of the one or more optimal nodes, wherein the data is associated with an action performed by each of the corresponding one or more optimal nodes;
update the influence value associated with each of the one or more optimal node based on difference between the action performed and the predicted action being determined; and
identify one or more optimal paths in the distributed network for transmitting the information to the one or more target nodes based on one of the influence value being updated and the action being performed by each of the one or more optimal nodes, wherein the action performed is one of forwarding the information to another node, sharing the information to at least one node and responding to the information received from the routing server.

10. The routing server as claimed in claim 9, wherein the instructions further configure the at least one processor to assign a path delta value for each path determined from a source node to a destination node in the distributed network.

11. The routing server as claimed in claim 9, wherein the instructions further configure the at least one processor to increase the influence value, associated with each of the one or more optimal nodes, by a value if the action performed by each of the one or more optimal nodes is same as the predicted action determined by the routing server.

12. The routing server as claimed in claim 9, wherein the instructions further configure the at least one processor to decrease the influence value, associated with each of the one or more optimal nodes, by a value if the operation performed by each of the one or more optimal nodes is different from the predicted action determined by the routing server.
